(19) United States
(12) Patent Application Publication
(10) Pub. No.: US 2007/0079521 A1
(43) Pub. Date: Apr. 12, 2007

(54) Measuring tool

(76) Inventor: Michael J. Hill, Cedar Falls, IA (US)

Correspondence Address: PATWRITE LLC, 408 W. MAIN ST., MARSHALLTOWN, IA, 50158-5759, US

(21) Appl. No.: 11/248,114

(22) Filed: Oct. 12, 2005

(51) Int. Cl. G01B 3/08

(52) U.S. Cl. 33/809

(57) ABSTRACT

An improved measuring tool. The improved measuring tool includes a first extensible section hingeably coupled to a second extensible section for rotation between a first position in which the sections are lateral to one another, and a second position in which the sections are substantially coaxial with one another. Means are provided for locking the sections in the coaxial orientation. Nested within the sections is a plurality of arms. When desired, the arms may be extended from one or both extensible sections to take measurements of an item. The measuring tool is also provided with a plurality of replaceable tips to allow measurement of angled material, such as door jambs and the like.

### BACKGROUND OF THE INVENTION

1. Field of the Invention

The present invention relates in general to a measuring device and, more particularly, to a portable measuring device extensible and adaptable to take a plurality of measurements.

2. Description of the Prior Art

Measuring devices have long been known in the prior art. Rigid devices such as rulers and yard sticks are useful when transportation of the measuring device is not an issue, and wherein the material to be measured is shorter than the length of the yardstick or ruler. It would be desirable, however, to provide a more portable device, adaptable to measure material both shorter and longer than such prior art devices.

It is also known in the art to provide flexible fabric tape measures. Although such tape measures are inexpensive and readily portable, the lack of rigidity associated with such measuring devices makes them difficult for use in taking accurate measurements or for use by a single user. The flexibility of such devices also severely limits their use in diagonal measurement situations, such as taking the diagonal measurement of a window or door jamb. It would, therefore, be desirable to provide a portable, rigid measuring system capable of supporting its own weight in diagonal measurement situations.

It is also known in the art to provide retractable steel tape measures. Such devices are portable and are extensible to great lengths. One drawback associated with such prior art devices, however, is that such tapes often crack or break when used repeatedly to measure long distances. Additionally, such devices are often provided with end hooks which may become loose or dislodged, making accurate measurements difficult. Another drawback associated with such devices is the tendency of steel tape to bend when stretched unsupported over long distances. Such tendency to bend often decreases the usefulness of such steel tape measures in situations where door jambs or the like are being measured diagonally. It would, therefore, be desirable to provide a portable device which is capable of supporting its own weight in diagonal measurement situations and which does not have such a tendency to break or fail upon repeated use.

Additionally, all of the foregoing devices utilize hash marks requiring an additional layer of estimating and recordation in replicating measurements. It would be desirable to provide a measuring system which did not require measurements be recorded. The drawbacks associated with the prior art noted hereinabove are substantially eliminated by the present invention.

### SUMMARY OF THE INVENTION

The present invention provides a first plurality of nested measurement sections, each having a triangular cross-section, hingeably connected to a second plurality of nested measurement sections, each also having a triangular cross-section. The hinge allows the nested sections to rotate from a first position lateral one another to a second position in which the nested sections are substantially coaxial with one another. A catch is provided for locking the sections in the coaxial orientation to allow one or both of the nested sections to be extended to record a measurement.

### BRIEF DESCRIPTION OF THE DRAWINGS

The present invention will now be described, by way of example, with reference to the accompanying drawings in which:

FIG. 1 illustrates a side elevation in cross-section of the measurement tool of the present invention;

FIG. 2 illustrates a perspective view of the knuckle and pin assemblies connecting the nested sections;

FIG. 3 illustrates a side elevation in cross-section of the coaxial catch and keeper mechanism associated with the present invention;

FIG. 4 illustrates a side elevation in partial cutaway of two nesting structures of the present invention;

FIG. 5 illustrates a perspective view of the measurement tool with one of the nested sections extended for measurement of a piece of lumber; and

FIG. 6 illustrates a perspective view of the measurement tool shown locked in the coaxial position with both nested sections extended, and taking the measurement of a door jamb.

### DETAILED DESCRIPTION OF THE PREFERRED EMBODIMENT

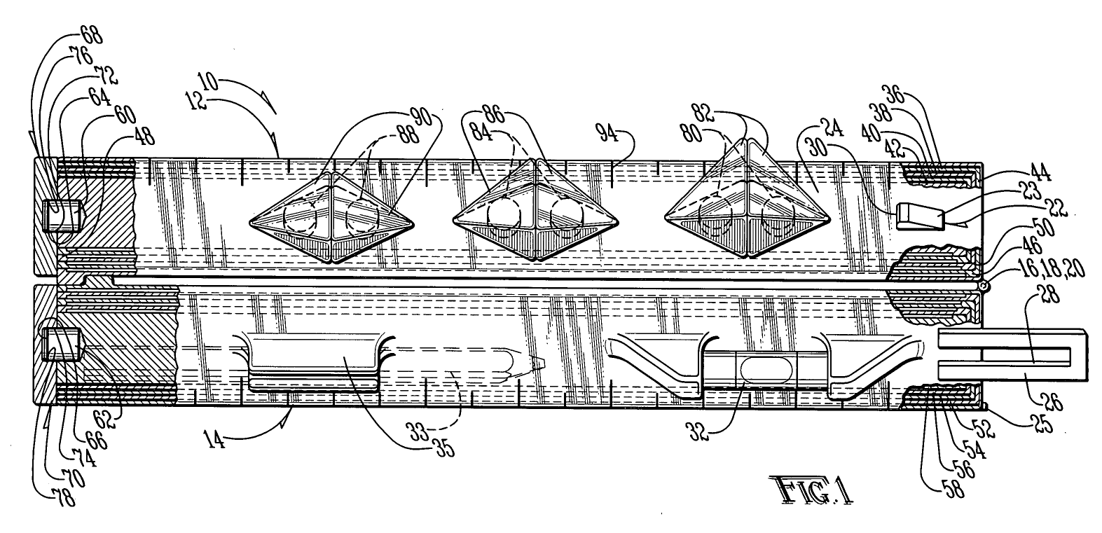

With reference to the drawings, a measuring tool is indicated generally as (10) in FIG. 1. The measuring tool (10) includes a first extensible section (12) and a second extensible section (14). The extensible sections (12) and (14) may be constructed of any suitable material and of any suitable dimensions and configurations. Preferably, the extensible sections (12) and (14) are injection molded of a high density polyethylene material, with an equilateral triangular cross section, with each face being 1.5 inches in width. The 1.5 inch width is particularly desirable as this length coincides with the width of dimensional lumber. Each of the extensible sections (12) and (14) is preferably between 2.0 and 200.0 inches long, more preferably between 5.0 and 50.0 inches long, and most preferably 10.0 inches long.

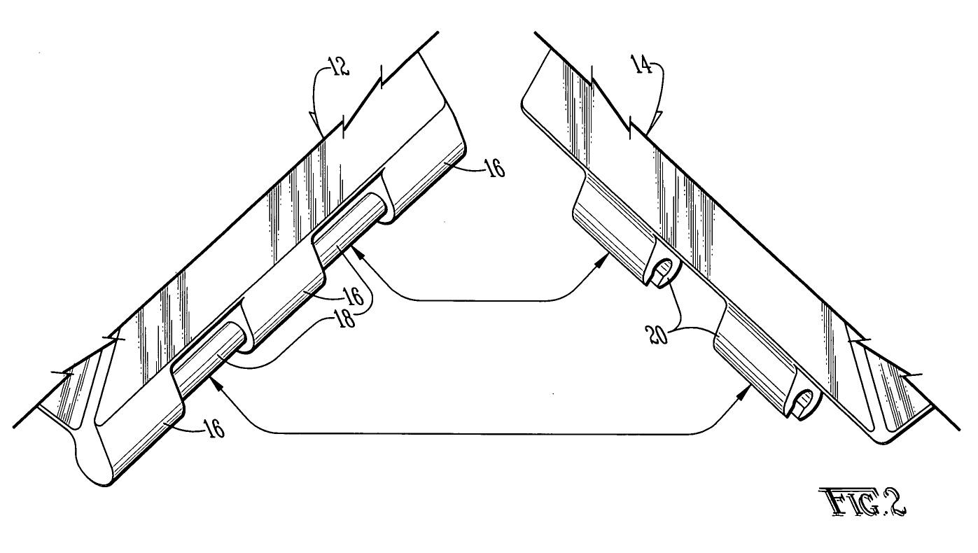

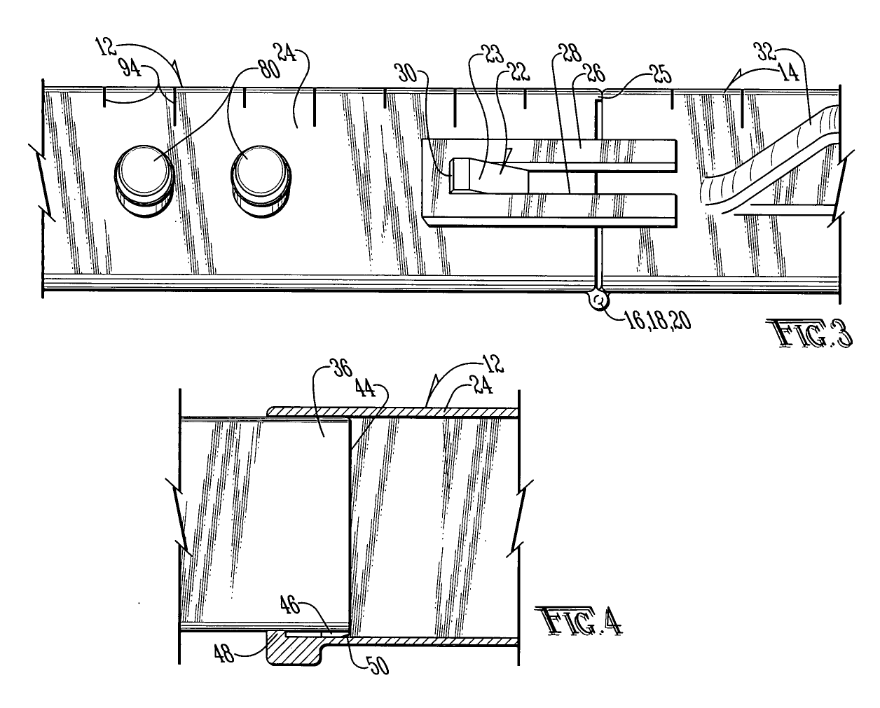

As shown in FIG. 2, the end of first extensible section (12) is preferably integrally molded with a plurality of shoulders (16) coupled to one another by a pair of pins (18). Similarly, the second extensible section (14) is preferably integrally molded with a pair of knuckles (20) which snap fit into engagement with the pins (18) to allow the first extensible section (12) to hingeably rotate relative to the second extensible section (14). The shoulders (16) and pins (18) are preferably lateral the end of the first extensible section (12) to allow the first extensible section (12) to be detached from the second extensible section (14) and set flush against a surface to be used independently of the second extensible section (14). As shown in FIGS. 1 and 3, the first extensible section (12) is also preferably provided with a catch (22), consisting of a ramp (23) integrally molded onto a face (24) of the first extensible section (12). The end of the second extensible section (14) is also preferably integrally molded with a spacer (25) of a sufficient length and durability to maintain the second extensible section (14) in a substantially coaxial orientation relative to the first extensible section (12).

As shown in FIG. 3, the second extensible section (14) is preferably integrally molded with a keeper (26) which is a flat portion of plastic provided with a hole (28) through which protrudes the catch (22) when the first extensible section (12) and second extensible section (14) are moved into coaxial alignment. As shown in FIG. 3, the catch (22) is preferably provided with a slight bevel (30) to allow the keeper (26) to move over the catch (22). The material used to construct the first extensible section (12) and second extensible section (14) are preferably slightly resilient to allow the keeper (26) to extend sufficiently over the catch (22) to retain the first extensible section (12) and second extensible section (14) in alignment.

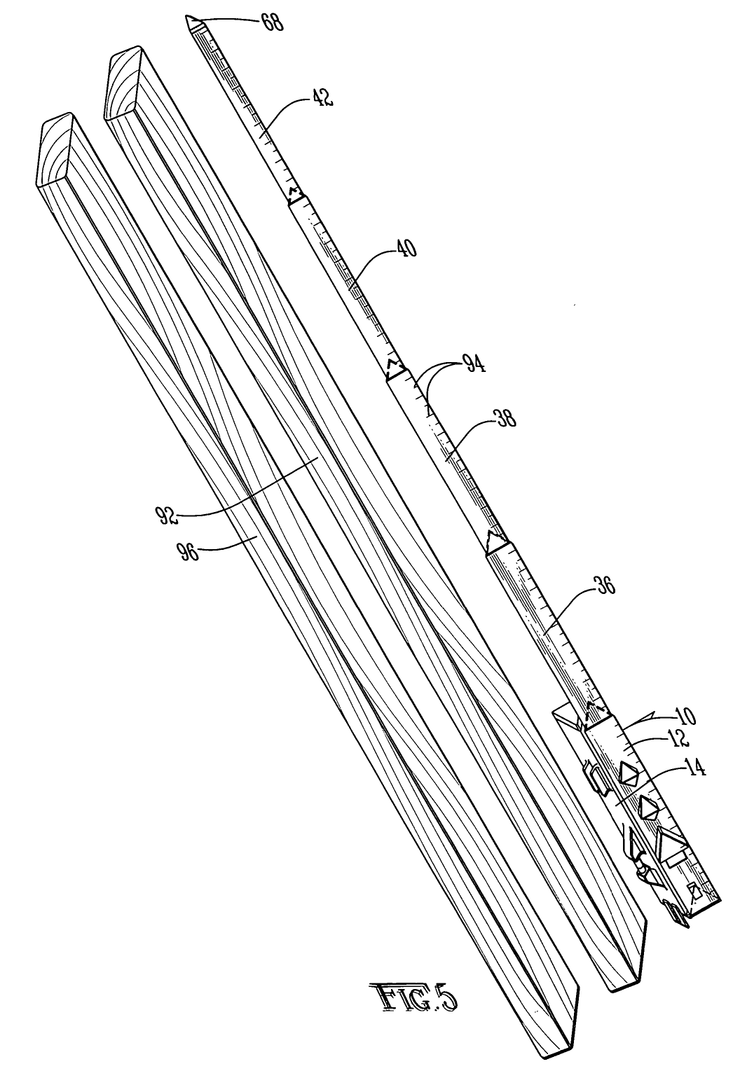

As shown in FIG. 1, the second extensible section (14) is also provided with a bubble level (32), such as those well known in the art to allow measurements to be taken along a true horizontal, and a pencil (33) and pencil retention clip (35), such as those known in the art to retain a pencil (33) until it is needed for marking a measurement and the like. As shown in FIG. 1, nested within the first extensible section (12) is a first arm (36). The first arm (36) is preferably hollow, and nested within the first arm (36) is a second arm (38). The second arm (38) is also hollow, within which is nested a third arm (40). Nested within the third arm (40) is a fourth arm (42). As shown in FIGS. 1 and 4, each of the arms (36), (38), (40) and (42) are nested in a manner in which the inner arm (36), (38), (40) or (42) is provided on its outward end (44) with a catch (46). The arms (36), (38) or (40) in which the other arms are nested are preferably provided with a block (48). As shown, the catch (46) is preferably provided with a bevel (50) to allow the interior arm (36), (38), (40) and (42) to slide into the exterior arm (36), (38) or (40) past the block (48) in a manner which prevents the catch (46) from moving in the opposite direction out of the exterior arm (36), (38), or (40) past the block (48). Alternatively, the arms (36), (38), (40) and (42) may be nested and retained in any manner known in the art.

As shown in FIG. 1, the second extensible section (14) is provided with a fifth arm (52), a sixth arm (54), a seventh arm (56), and an eighth arm (58) nested in a manner similar to that described above in association with the first extensible section (12). The fourth arm (42) and eighth arm (58) are each provided with a pin (60) and (62) which extends outward and is provided with a shallow, slightly resilient lip (64) and (66). Releasably secured over the pins (60) and (62) are a pair of butt tips (68) and (70). The butt tips (68) and (70) are each provided with a hole (72) and (74), each defining a detent (76) and (78) to engage the lips (64) and (66) of the pins (60) and (62). Alternatively, the pins (60) and (62), and butt tips (68) and (70), may be threaded if more positive engagement is desired. The pins (60) and (62) may also be pivotably coupled to the fourth arm (42) and eighth arm (58) if desired. The first extensible section (12) is also preferably provided on its face (24) with a first pair of pins (80) securing a pair of 45.0 degree angled tips (82), another pair of pins (84) securing a pair of 30.0 degree angled tips (86), and yet another pair of pins (88) securing a pair of 22.5 degree angled tips (90). The angled tips (82), (86) and (90) are preferably also injection molded of high density polyethylene and are secured to the first extensible section (12) in the same manner in which the butt tips (68) and (70) are secured to the pins (60) and (62). The tips (82), (86) and (90) are preferably secured reasonable fast, yet not so secure as to prevent their removal when desired, for replacement over the pins (60) and (62). When the butt tips (68) and (70) are replaced, the butt tips (68) and (70) are secured to the corresponding pair of pins (80), (84) or (88), which previously housed the new pair of angled tips (82), (86) and (90), subsequently secured to the pins (60) and (62).

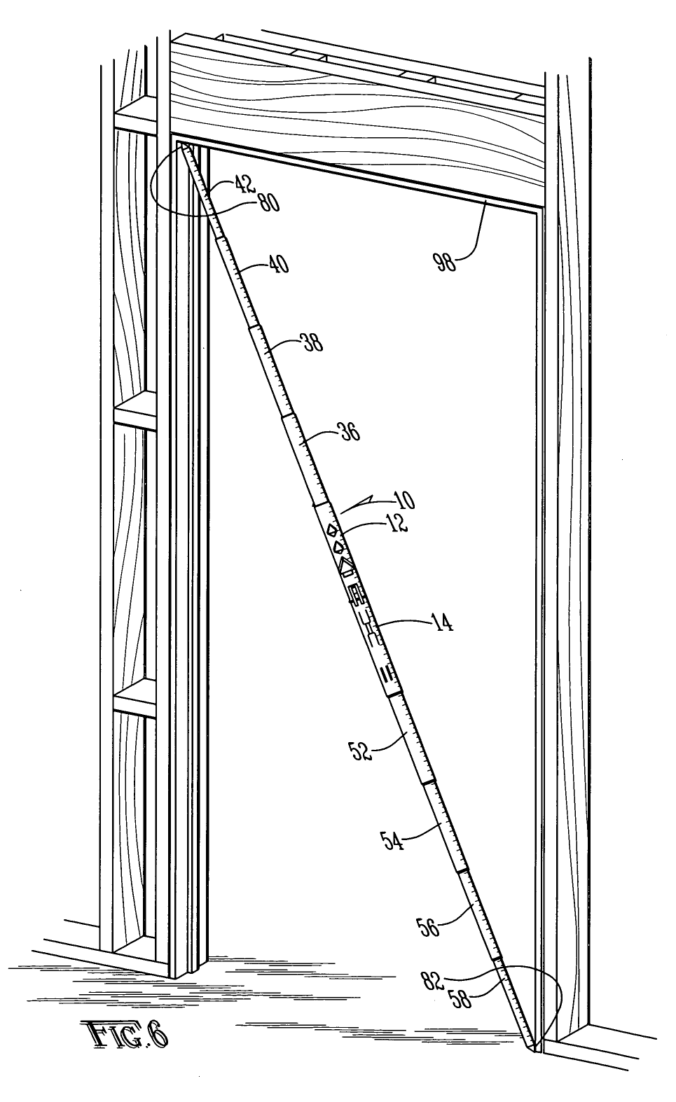

As shown in FIG. 5, when it is desired to take a measurement of an item, such as a piece of dimensional lumber (92), 83.0 inches or less in length, the butt tip (68) is grasp and pulled outwardly from the first extensible section (12) to the length of the dimensional lumber (92). The first extensible section (12), second extensible section (14), and the arms (36), (38), (40), (42), (52), (54), (56) and (58) are all preferably provided with hash marks (94) corresponding to incremental distances. The hash marks (94) allow the piece of dimensional lumber (92) to be measured using the measuring tool (10). Alternatively, the arms (36), (38), (40) and (42) are preferably friction fit tightly enough within the first extensible section (12) to allow their positions to be maintained after extension. This allows the arms (36), (38), (40) and (42) to be extended from the first extensible section (12) to the length of the dimensional lumber (92), and moved to a second piece of dimensional lumber (96) to allow that second piece of dimensional lumber (96) to be compared to, and if desired, measured for cutting and sizing to, the first piece of dimensional lumber (92).

If it is desired to measure a material longer than 83.0 inches, such as the diagonal measure of a door frame (98), the first extensible section (12) may be rotated relative to the second extensible section (14) until the catch (22) engages the keeper (28) and locks the first extensible section (12) into substantially coaxial alignment with the second extensible section (14). Thereafter, the butt tips (68) and (70) may be grasped and extended outward to the full diagonal dimension of the door frame (98). (FIG. 6). In this type of measuring situation, it is desirable to remove the 45.0 degree angle tips (82) from the pair of pins (80) and replace the butt tips (68) and (70). (FIGS. 1 and 6). Once the 45.0 degree angle tips (82) have been secured to the pins (60) and (62), the butt tips (68) and (70) may be secured to the now vacant pair of pins (80) provided on the first extensible section (12). Utilizing the 45.0 degree angle tips (82), the measuring tool (10) can obtain a more accurate measurement of the diagonal dimension of the door frame (98), to confirm whether the door frame is “square.” Alternatively, the pins (60) and (62) may be pivotably secured to the fourth arm (42) and eighth arm (58), and/or the tips (68), (70), (82), (86) or (90) may be pivotably secured to the pins (60) and (62).

Although the invention has been described with respect to a preferred embodiment thereof, it is to be understood that it is not to be so limited, since changes and modifications can be made therein which are within the full, intended scope of this invention as defined by the appended claims. For example, it is anticipated that the measuring tool may be constructed of any suitable dimensions and of any suitable material. It is additionally anticipated that any desired number of arms may be nested within the extensible sections (12) and (14). It is further anticipated that a diode laser or other remote measuring aid may be secured to the measuring tool (10).

What is claimed is:

1. A measuring tool comprising:
(a) a first housing;
(b) a second housing;
(c) means for pivoting said first housing and said second housing from a first position substantially lateral with one another to a second position substantially coaxial with one another;
(d) a first extension arm nested within said first housing;
(e) a second extension arm nested within said second housing;
(f) a third extension arm nested within said first housing;
(g) a fourth extension arm nested within said second housing;
(h) a first tip coupled to said third extension arm; and
(i) a second tip coupled to said fourth extension arm.

2. The measuring tool of claim 1, wherein said first housing and said second housing are provided with a substantially triangular cross-section.

3. The measuring tool of claim 1, wherein said pivoting means is a hinge.

4. The measuring tool of claim 1, further comprising means for securing said first housing and said second housing in said second position.

5. The measuring tool of claim 4, wherein said first tip is releasably secured to said third extension arm and said second tip is releasably secured to said fourth extension arm.

6. The measuring tool of claim 1, further comprising a level coupled to said first housing.

7. The measuring tool of claim 1, further comprising measuring increments provided on said first housing.

8. The measuring tool of claim 1, wherein said first tip is pivotably secured to said third extension arm and said second tip is pivotably secured to said fourth extension arm.

9. The measuring tool of claim 1, wherein said pivoting means comprises a pin coupled to said first housing and a knuckle coupled to said second housing, wherein said knuckle is coupled at least partially around said pin.

10. The measuring tool of claim 9, further comprising a keeper coupled to said first housing and a catch coupled to said second housing.

11. The measuring tool of claim 1, further comprising:
(a) a fifth extension arm provided within said first extension arm and around said third extension arm;
(b) a sixth extension arm provided within said second extension arm and around said fourth extension arm;
(c) a seventh extension arm provided within said fifth extension arm and around said third extension arm; and
(d) an eighth extension arm provided within said sixth extension arm and around said fourth extension arm.

12. The measuring tool of claim 1, wherein said first tip is provided with a substantially forty-five degree angle at its furthest point from said third extension arm.

13. The measuring tool of claim 1, wherein said first housing is at least six inches in length and is no greater than fifteen inches in length.

14. A measuring tool comprising:
(a) a first extension assembly comprising:
(i) a first housing;
(ii) a first extension arm provided within said first housing;
(iii) a second extension arm provided within said first extension arm;
(iv) a third extension arm provided within said second extension arm; and
(v) a first tip coupled to said third extension arm;
(b) a second extension assembly comprising:
(i) a second housing
(ii) a fourth extension arm provided within said second housing;
(iii) a fifth extension arm provided within said fourth housing;
(iv) a sixth extension arm provided within said fifth housing; and
(v) a second tip coupled to said sixth extension arm.
(c) a hinge coupling said first extension assembly to said second extension assembly; and
(d) means for maintaining said first extension arm substantially coaxial with said second extension arm.

15. The measuring tool of claim 14, wherein said first housing, said first extension arm, said second extension arm, said third extension arm, said fourth extension arm, said fifth extension arm and said sixth extension arm are provided with a substantially triangular cross-section.

16. The measuring tool of claim 14, wherein said first extension arm is sufficiently friction fit within said first housing to retain said first extension arm in a plurality of positions relative to said first housing.

17. The measuring tool of claim 14, further comprising a third tip releasably coupled to said first housing.

18. The measuring tool of claim 17, wherein said third tip is provided with a forty-five degree angle.

19. A measuring tool comprising:
(a) a first extension assembly comprising:
(i) a first housing having a triangular cross-section;
(ii) a first extension arm coupled within said first housing in a manner which frictionally maintains said first extension arm at a plurality of extensions from said first extension arm;
(iii) a second extension arm coupled within said first extension arm in a manner which frictionally maintains said second extension arm at a plurality of extensions from said first extension arm; and
(iv) a third extension arm coupled within said second extension arm in a manner which frictionally maintains said third extension arm at a plurality of extensions from said second extension arm.
(b) a second extension assembly comprising;
(i) a second housing having a triangular cross-section;
(ii) a fourth extension arm coupled within said second housing in a manner which frictionally maintains said fourth extension arm at a plurality of extensions from said second housing;
(iii) a fifth extension arm coupled within said fourth extension arm in a manner which frictionally maintains said fifth extension arm at a plurality of extensions from said fourth extension arm;
(iv) a sixth extension arm coupled within said fifth extension arm in a manner which frictionally maintains said sixth extension arm at a plurality of extensions from said fifth extension arm; and
(c) a hinge coupling said first extension assembly to said second extension assembly.

20. The measuring tool of claim 19, further comprising means for locking said first extension assembly in substantially coaxial alignment with said second extension assembly.
